(19) United States
(12) Patent Application Publication
(10) Pub. No.: US 2005/0193607 A1
(43) Pub. Date: Sep. 8, 2005

(54) Indoor modular panoramic signs

(76) Inventors: Reuven Maman, Nahariya (IL); Israel Maman, Nahariya (IL)

Correspondence Address: Angenehm Law Firm, Ltd., P.O. Box 48755, Coon Rapids, MN, 55448-0755, US

(21) Appl. No.: 11/037,873

(22) Filed: Jan. 18, 2005

(30) Foreign Application Priority Data
Feb. 14, 2002 (IL) 148158

(51) Int. Cl. G09F 7/00

(52) U.S. Cl. 40/620; 40/611.01

(57) ABSTRACT

An indoor modular panoramic sign attached by insertion in grooves or by press action or glued or screwed.

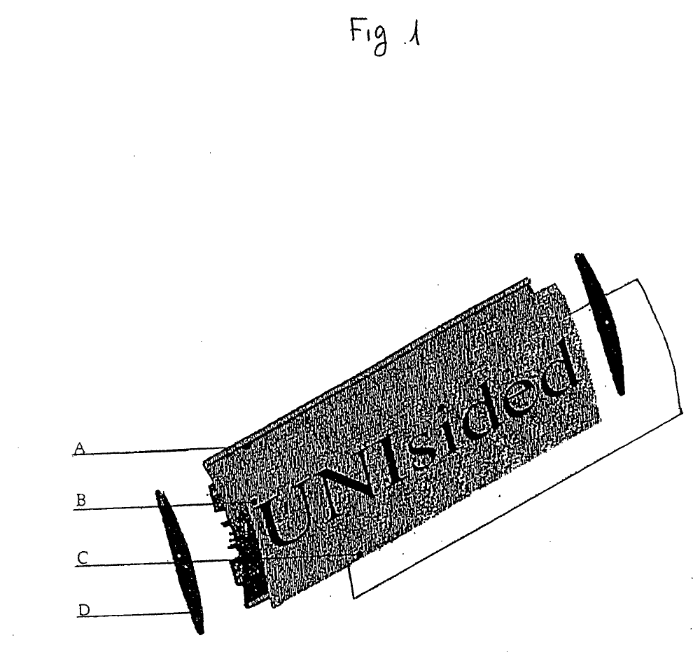

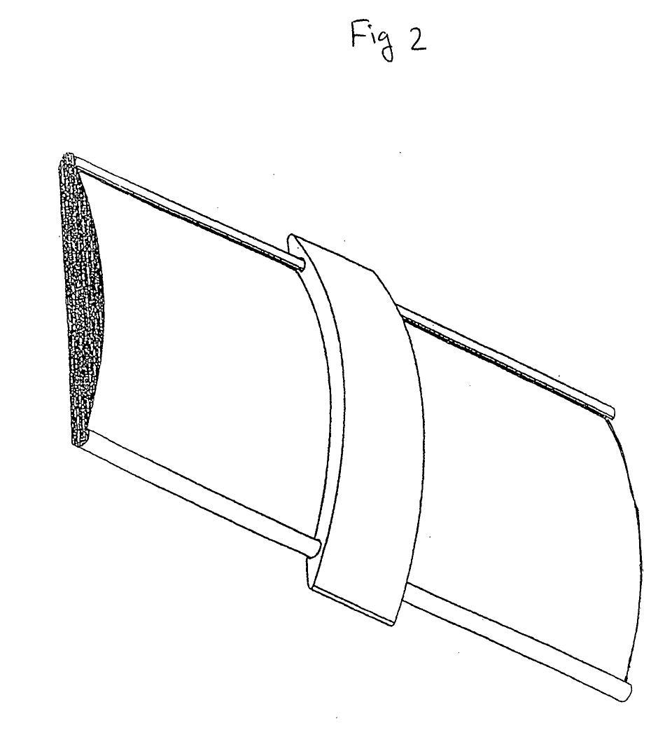

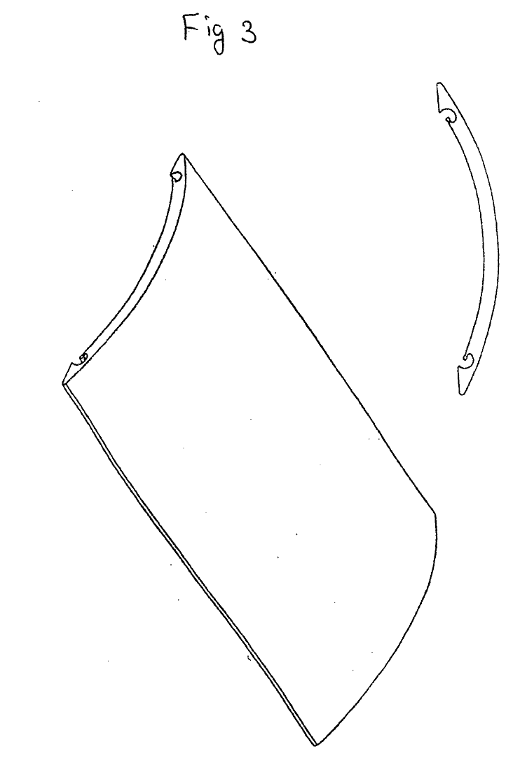

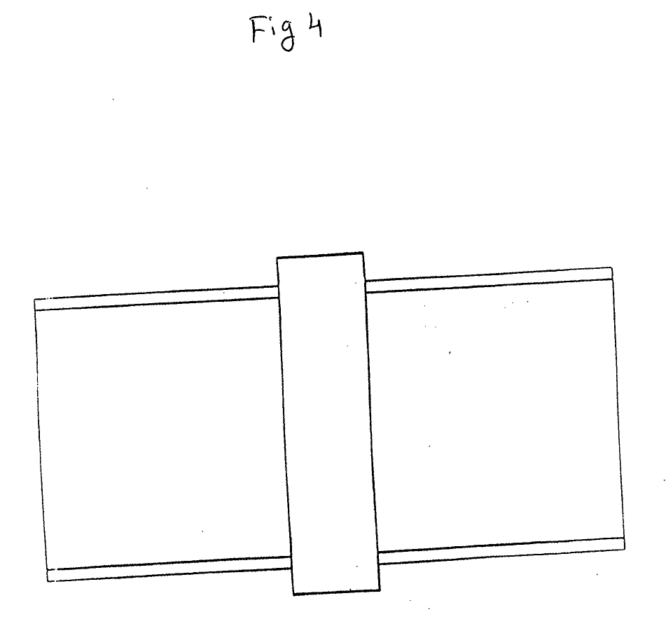

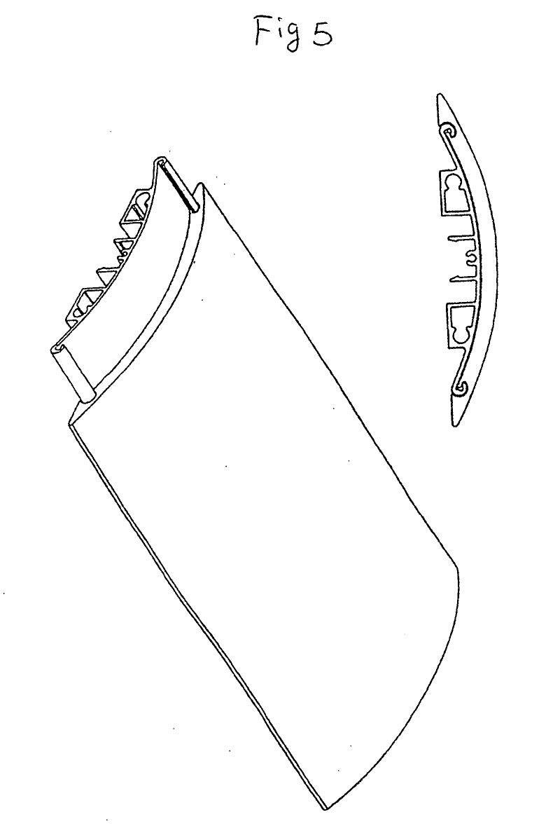

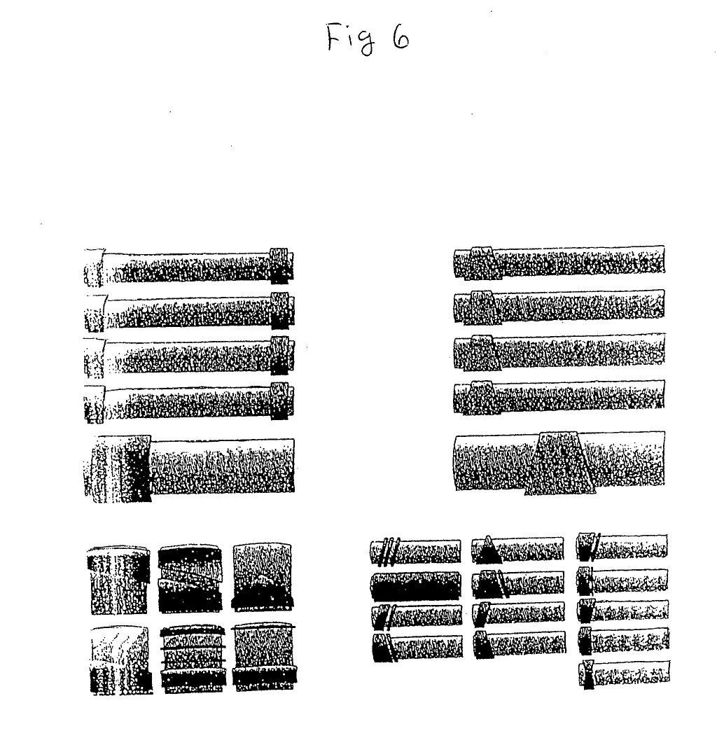

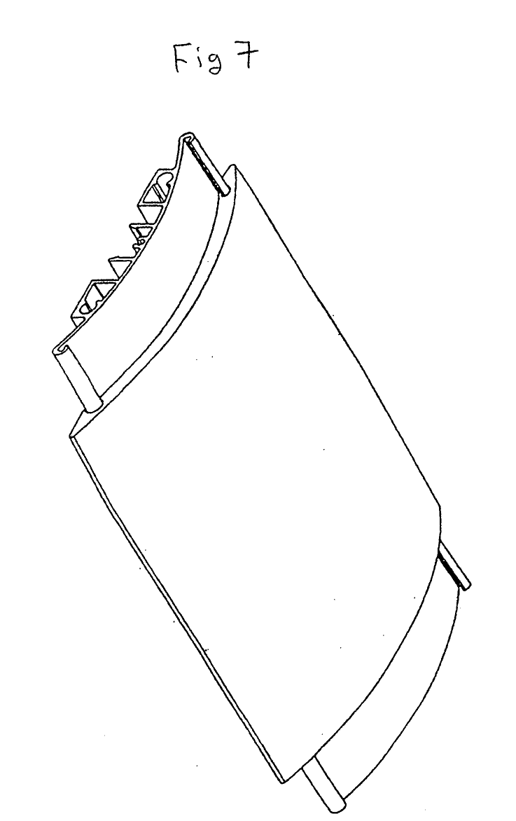

The signs most widely in use today are constructed from four sections: the base of the sign, graphics, covers and a transparent covering to protect the graphics.

These signs are able to provide among other things, the possibility of combining between the printer and modular body.

These signs are manufactured in a number of countries in the world. One of the disadvantages of these signs is the need to use special and complicated means in the manufacture of the sign andf draw the attention of the viewer. Another disadvantage is the difficulty of connecting the basic fixture to the sign.

The objective is to develop a modular characteristic element that will provide for the a simple, convenient connection to the surface.

Another advantage of the invention is the large number of variation that can be produced with simplicity and speed.

Yet another advantage is to develop a mobile characteristic element that exposes different parts of the sign.

The characteristic element can be manufactured from a variety of materials available in industry such as: aluminum, plastic, etc. In additional forms the characteristic element is built with insertionable grooves/press action for Indoor Signs.

An example of the operation of the invention will be explained in the attached drawings.

### DRAWINGS

Drawing No. 1—view of panoramic sign.

Drawing No. 2—there dimensional view of sign with characteristic element.

Drawing No. 3—frontal view of sign with characteristic element.

Drawing No. 4—side view of characteristic element.

Drawing No. 5—view of characteristic element that fits into the grooves of the sign.

Drawing No. 6—view of certain possible variation of the characteristic element.

Drawing No. 7—view of the moving/shifting possibilities of characteristic element.

As can be view in drawing No. 1 the existing signs can be manufactured with different attached bases, however the finished product including the graphics has a similar look.

The characteristic element of the three dimensional in drawing No. 2 shows the new invention that is attached to the existing signs shown in drawing No. 1.

In drawing No. 3 we see the overhead view of the sign with the characteristic element.

The method of connection between the sign and the characteristic element can be seen in drawing No. 5 and the connection can also be made with press action clipping two characteristic elements together.

Drawing No. 6 only some of the possible variation are shown.

In drawing No. 7 we see the possibilities of moving/shifting characteristic elements in such a way so as to reveal different sections of the sign.

Any person in the trade will understand the variation that can be achieved from the form in drawing No. 6 and they are only some of the invention that follows.

1: Characteristic element that can and will be manufactured from a variety of the materials used in the industries such as aluminum, plastic etc'.

2: Characteristic element that can and will be manufactured from a variety of sectional shapes.

3: The method of connection of claim No. 1, will be by insertion in grooves by press action or glued or screwed.

4: The characteristic element cn be in a variety of geometric variation.

5: The characteristic element can if required, move on the grooves of the sign for the purposes of showing or hiding sections of the sign.
